(19) United States
(12) Patent Application Publication
(10) Pub. No.: US 2026/0221349 A1
(43) Pub. Date: Jul. 30, 2026

(54) CAPACITOR, ELECTRICAL CIRCUIT, CIRCUIT BOARD, DEVICE, AND METHOD FOR MANUFACTURING CAPACITOR

(71) Applicant: Panasonic Intellectual Property Management Co., Ltd., Osaka (JP)

(72) Inventors: Hisanori MASHIKO, Osaka (JP); Naoya KITAMURA, Osaka (JP); Hiroshi ASANO, Osaka (JP); Manabu KANOU, Osaka (JP); Ryosuke KIKUCHI, Osaka (JP)

(21) Appl. No.: 19/629,395

(22) Filed: Mar. 26, 2026

Related U.S. Application Data
(63) Continuation of application No. PCT/JP2025/014381, filed on Apr. 10, 2025.

(30) Foreign Application Priority Data
Jul. 18, 2024 (JP) 2024-114539

(51) Int. Cl. H01G 9/07

(52) U.S. Cl. CPC H01G 9/07

(57) ABSTRACT

A capacitor includes metallic tantalum and a dielectric layer. The dielectric layer covers the metallic tantalum and includes a tantalum oxide. The dielectric layer includes fluorine and phosphorus. The dielectric layer includes, for example, a first portion and a second portion. The first portion is a portion separated from the metallic tantalum in a thickness direction of the dielectric layer. The second portion is a portion in contact with the metallic tantalum in the thickness direction of the dielectric layer.

This application is a continuation of PCT/JP2025/014381 filed on Apr. 10, 2025, which claims foreign priority of Japanese Patent 2024-114539 filed on Jul. 18, 2024, the entire contents of both of which are incorporated herein by reference.

### BACKGROUND OF THE INVENTION

### 1. Field of the Invention

The present invention relates to a capacitor, an electrical circuit, a circuit board, an apparatus, and a capacitor manufacturing method.

### 2. Description of Related Art

Fluorine-containing tantalum oxides have been included in capacitors.

For example, JP 7122617 B1 describes a capacitor including a dielectric including an amorphous tantalum compound containing fluorine and oxygen. This dielectric has a higher relative permittivity than a dielectric including a fluorine-free tantalum oxide. This dielectric is obtained, for example, by sputtering or anodic oxidation.

WO 2023/234343 A1 describes a capacitor including metallic tantalum, an electrical conductor, and a tantalum oxide film. The tantalum oxide film is disposed in contact with the metallic tantalum, and is disposed between the metallic tantalum and the electrical conductor. The tantalum oxide film includes a fluorine-including first portion and a second portion. The second portion is closer to the metallic tantalum than the first portion in the thickness direction of the tantalum oxide film. The fluorine concentration in the second portion is lower than that in the first portion. The dielectric loss tangent is reduced in this capacitor. The tantalum oxide film is formed, for example, by anodic oxidation.

### SUMMARY OF THE INVENTION

The present disclosure provides a capacitor advantageous in terms of capacitance and withstand voltage.

A capacitor of the present disclosure includes:
metallic tantalum; and
a dielectric layer covering the metallic tantalum and including a tantalum oxide, wherein
the dielectric layer includes fluorine and phosphorus.

The present disclosure can provide a capacitor advantageous in terms of capacitance and withstand voltage.

### BRIEF DESCRIPTION OF THE DRAWINGS

FIG. 1 is a cross-sectional view showing an example of the capacitor of the present disclosure.

FIG. 2 is a cross-sectional view showing another example of the capacitor of the present disclosure.

FIG. 3A schematically shows an example of the electrical circuit of the present disclosure.

FIG. 3B schematically shows an example of the circuit board of the present disclosure.

FIG. 3C schematically shows an example of the apparatus of the present disclosure.

FIG. 4 is a flowchart showing an example of the capacitor manufacturing method of the present disclosure.

FIG. 5 is a graph showing a relation between signal intensities of F⁻, PO²⁻, TaO³⁻, and O⁻ and the depth in a depth profile obtained from a sample according to Example 1 by time-of-flight secondary ion mass spectrometry (TOF-SIMS).

FIG. 6 is a graph showing the results of X-ray diffraction (XRD) measurement of a sample according to Example 2 and metallic tantalum.

### DETAILED DESCRIPTION

(Findings on which the Present Disclosure is Based)

There is a continuous demand, for example, for improving processing performance of electronic apparatuses. Performance of an electronic component, such as a capacitor, greatly affects performance of an electronic apparatus in which the electronic component is embedded. Therefore, it is expected that there will be an increasing need for small high-performance capacitors. Electrolytic capacitors, for example, are known as capacitors. In an electrolytic capacitor, a dielectric of a thin oxidized film is formed on a surface of metallic aluminum or metallic tantalum by chemical conversion of aluminum or tantalum. The capacitance of an electrolytic capacitor is increased mainly by increasing the specific surface area of a dielectric layer. However, this has limitations. It is thought that developing a dielectric having higher permittivity and higher withstand voltage enables further improvement in capacitor performance.

According to JP 7122617 B1, a dielectric including a fluorine-containing amorphous tantalum oxide has a higher relative permittivity than that of a dielectric including a fluorine-free tantalum oxide. Hence, a capacitor including a fluorine-containing tantalum oxide is expected to have a higher capacitance.

In WO 2023/234343 A1, a dielectric layer is obtained by anodic oxidation of tantalum in an aqueous solution containing fluorine ions. According to WO 2023/234343 A1, it is shown that there are conditions under which a dielectric loss tangent of an anodic film becomes high. Furthermore, it is understood from WO 2023/234343 A1 that by performing additional anodic oxidation of tantalum in a fluorine-containing aqueous solution after anodic oxidation thereof in a fluorine-free aqueous solution, the dielectric loss tangent of the dielectric formed of the fluorine-containing amorphous tantalum oxide is decreased. As just described, when a capacitor including a certain fluorine-containing tantalum oxide is used, reduction of the dielectric loss tangent of a dielectric included in the capacitor is expected to be achieved. It should be noted that a dielectric having a low dielectric loss tangent has an advantage in reducing an electrical energy loss in a capacitor. A high withstand voltage of a capacitor is also important.

In view of such circumstances, the present inventors made intensive studies to discover a configuration capable of increasing the capacitance and the withstand voltage of a capacitor including a dielectric layer including a fluorine-containing tantalum oxide. As a result, the present inventors have newly found that the capacitance and the withstand voltage of a capacitor can be increased by a dielectric layer having a given configuration. The present inventors have completed the capacitor manufacturing method of the present disclosure on the basis of this new finding.

### EMBODIMENTS

Embodiments of the present disclosure will be described hereinafter with reference to the drawings. The present disclosure is not limited to embodiments given below.

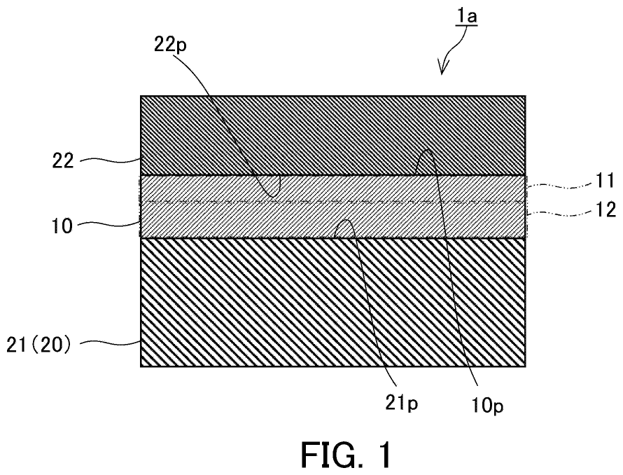

FIG. 1 is a cross-sectional view showing an example of the capacitor of the present disclosure. As shown in FIG. 1, a capacitor 1a includes metallic tantalum 20 and a dielectric layer 10. The dielectric layer 10 covers the metallic tantalum and includes a tantalum oxide. The tantalum oxide is, for example, amorphous. The tantalum oxide may include a crystalline phase. The dielectric layer 10 includes fluorine and phosphorus. This configuration is likely to increase the capacitance and the withstand voltage of the capacitor 1a. The capacitor 1a is produced, for example, by a method including (I) and (II) described below. The fluorine included in the dielectric layer 10 is derived from, for example, fluoride contained in the solution in (I). At least a portion of the phosphorus included in the dielectric layer 10 is derived from, for example, a pH adjuster contained in the solution in (I).

In the capacitor 1a, the withstand voltage of the dielectric layer 10 is, for example, 4 V or more, and is desirably 10 V or more.

As shown in FIG. 1, the dielectric layer 10 includes, for example, a first portion 11 and a second portion 12. The first portion 11 is a portion separated from the metallic tantalum 20 in a thickness direction of the dielectric layer 10. The second portion 12 is a portion in contact with the metallic tantalum 20 in the thickness direction of the dielectric layer 10. The first portion 11 and the second portion 12 include fluorine. A concentration of phosphorus in the first portion 11 is higher than a concentration of phosphorus in the second portion 12. This configuration is likely to further increase the capacitance and the withstand voltage of the capacitor 1a.

The second portion 12 may be free of phosphorus.

As shown in FIG. 1, the first portion 11 includes a surface 10p of the dielectric layer 10. The surface 10p is a surface of the dielectric layer 10, the surface being separated from the metallic tantalum 20 in the thickness direction of the dielectric layer 10. In other words, the dielectric layer 10 includes phosphorus in the surface 10p. This configuration is likely to further increase the capacitance and the withstand voltage of the capacitor 1a.

As shown in FIG. 1, the capacitor 1a includes a first electrode 21 and a second electrode 22. The metallic tantalum 20 is included in the first electrode 21. The dielectric layer 10 is disposed, for example, between the first electrode 21 and the second electrode 22 in the thickness direction of the dielectric layer 10. The first electrode 21 has a principal surface 21p formed of the metallic tantalum 20. One principal surface of the dielectric layer 10 is in contact with the principal surface 21p. The second electrode 22 has, for example, a principal surface 22p parallel to the principal surface 21p. The other principal surface of the dielectric layer 10 is in contact with the principal surface 22p.

The first electrode 21 may be, for example, an anodizable alloy including the metallic tantalum 20 as its main component.

The second electrode 22 may include an electrolyte solution. The second electrode 22 may include an electrically conductive polymer. The second electrode 22 may include an electrical conductor used for an upper electrode disposed distant from a matrix of a circuit board where the capacitor 1a is to be mounted.

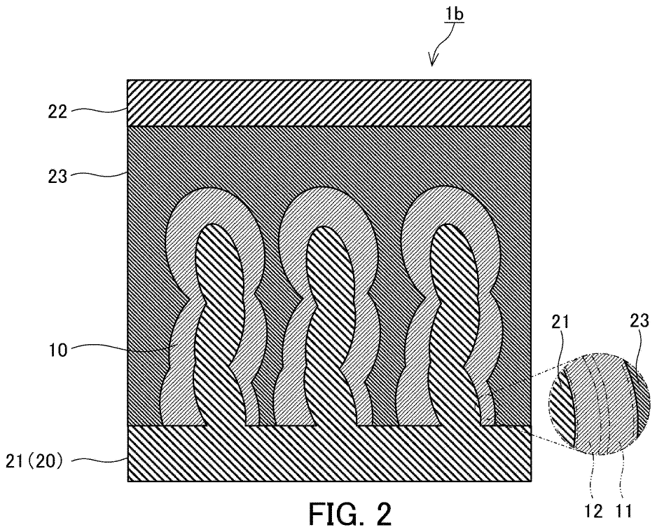

FIG. 2 is a cross-sectional view showing another example of the capacitor of the present disclosure. A capacitor 1b shown in FIG. 2 is configured in the same manner as the capacitor 1a unless otherwise described. The components of the capacitor 1b that are the same as or correspond to the components of the capacitor 1a are denoted by the same reference characters, and detailed descriptions of such components are omitted. The description given for the capacitor 1a is applicable to the capacitor 1b unless there is a technical inconsistency.

As shown in FIG. 2, the first electrode 21 of the capacitor 1b includes the metallic tantalum 20, and at least a portion of the metallic tantalum 20 is porous. This can increase the surface area of the metallic tantalum 20, thereby enabling the capacitor 1b to have a high capacitance. The porous structure can be formed, for example, by etching of a metallic foil or sintering of powder.

The dielectric layer 10 is disposed on a surface of the porous portion of the metallic tantalum 20. The dielectric layer 10 forms, for example, an anodic film, as described above.

As shown in FIG. 2, the capacitor 1b further includes an electrolyte 23. The electrolyte 23 is disposed between the first electrode 21 and the second electrode 22. In this case, the capacitor 1b is more likely to have a high capacitance.

The electrolyte 23 is not limited to a particular electrolyte. The electrolyte 23 includes, for example, at least one selected from the group consisting of an electrolyte solution, a solid electrolyte, and an electrically conductive polymer. Examples of the electrically conductive polymer include polypyrrole, a polythiophene, polyaniline, and derivatives of these. The electrolyte may be a manganese compound, such as manganese oxide.

The electrolyte 23 is disposed, for example, so as to fill a space around the porous portion of the metallic tantalum 20. The second electrode 22 may include, for example, a solidified body of a silver-including paste, a carbon material such as graphite, or both the solidified body and the carbon material.

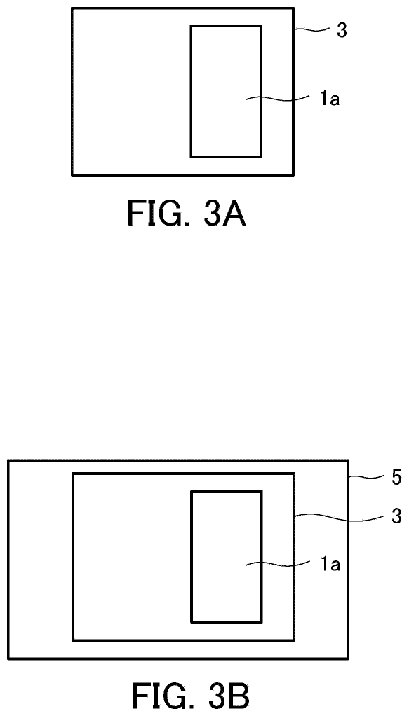

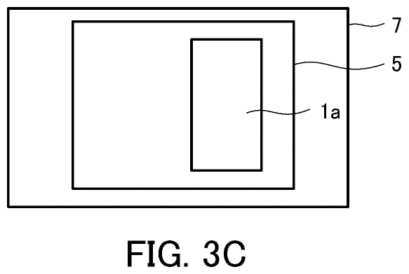

FIG. 3A schematically shows an example of the electrical circuit of the present disclosure. An electrical circuit 3 includes the capacitor 1a. The electrical circuit 3 may be an active circuit or a passive circuit. The electrical circuit 3 may be a discharging circuit, a smoothing circuit, a decoupling circuit, or a coupling circuit. Since the electrical circuit 3 includes the capacitor 1a, the electrical circuit 3 is likely to exhibit desired performance. For example, noise is likely to be reduced in the electrical circuit 3. The electrical circuit 3 may include the capacitor 1b.

FIG. 3B schematically shows an example of the circuit board of the present disclosure. As shown in FIG. 3B, a circuit board 5 includes the capacitor 1a. For example, the circuit board 5 includes the electrical circuit 3 including the capacitor 1a. Since the circuit board 5 includes the capacitor 1a, the circuit board 5 is likely to exhibit desired performance. The circuit board 5 may be an embedded board or a motherboard. The circuit board 5 may include the capacitor 1b.

FIG. 3C schematically shows an example of the apparatus of the present disclosure. As shown in FIG. 3C, an apparatus 7 includes the capacitor 1a. The apparatus 7 includes, for example, the circuit board 5 including the capacitor 1a. Since the apparatus 7 includes the capacitor 1a, the apparatus 7 is likely to exhibit desired performance. The apparatus 7 may be an electronic device, a communication device, a signal-processing device, or a power-supply device. The apparatus 7 may be a server, an AC adapter, an accelerator, or a flat-panel display such as a liquid crystal display (LCD). The apparatus 7 may be a USB charger, a solid-state drive (SSD), an information terminal such as a PC, a smartphone, or a tablet PC, or an Ethernet switch. The apparatus 7 may include the capacitor 1b.

In production of a capacitor including a dielectric layer including a fluorine-containing tantalum oxide, anodic oxidation can be performed using a fluorine ion-containing solution to form the dielectric layer, as described in JP 7122617 B1 and WO 2023/234343 A1. A relatively long anodic oxidation time is thought to be advantageous in densifying the anodic film and reducing variations in properties of the anodic film. Densification of the anodic film can contribute to improvement in withstand voltage. However, studies by the present inventors have newly revealed that it is not necessarily possible to increase the capacitance and the withstand voltage of a capacitor when a dielectric layer including a fluorine-containing tantalum oxide is formed by a long-term anodic oxidation.

In view of such circumstances, the present inventors made intensive studies to discover a method capable of increasing the capacitance and the withstand voltage of a capacitor in the case of forming a dielectric layer including a fluorine-containing tantalum oxide by a long-term anodic oxidation. As a result, the present inventors newly found that a dielectric layer capable of increasing the capacitance and the withstand voltage of a capacitor even when the anodic oxidation time is long can be formed by performing anodic oxidation using a given solution. On the basis of this new finding, the present inventors have completed the capacitor manufacturing method of the present disclosure.

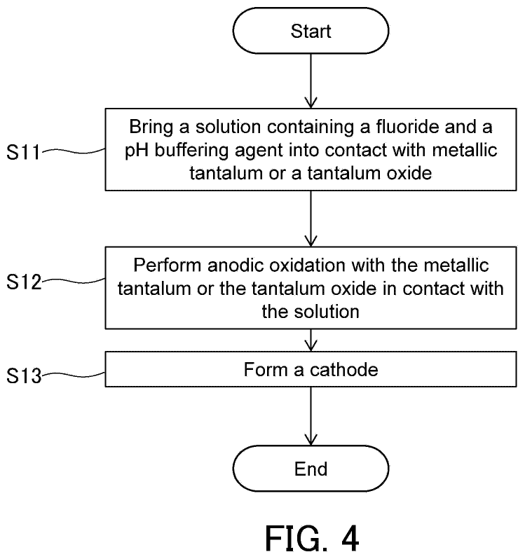

FIG. 4 is a flowchart showing an example of the capacitor manufacturing method of the present disclosure. As shown in FIG. 4, a capacitor is manufactured by a method including (I) and (II) below.
(I) Bringing a solution into contact with metallic tantalum or a tantalum oxide covering the metallic tantalum, the solution containing a fluoride including a fluoride ion (F⁻) and a pH buffering agent.
(II) Forming a dielectric layer covering the metallic tantalum by anodic oxidation with the metallic tantalum or the tantalum oxide in contact with the solution.

Since the solution used for the anodic oxidation contains the fluoride, a dielectric layer including a fluorine-containing tantalum oxide can be formed. Moreover, since the solution contains the pH buffering agent, the capacitance and the withstand voltage of a capacitor are likely to increase even when the anodic oxidation time is long.

For example, if a solution that is free of a pH buffering agent is used and the anodic oxidation time is long, the anodic oxidation may locally decrease the pH around the surface of the anode and may cause dissolution of the oxidized film, or the fluorine concentration may increase at the interface between the metallic tantalum and the dielectric layer. That can decrease insulation properties of the dielectric layer, making it difficult to produce a capacitor having a desired capacitance and a desired withstand voltage.

In the anodic oxidation, a decrease in pH of the fluorine-containing solution can result in generation of hydrogen fluoride. In this case, a countermeasure against the generated hydrogen fluoride is required, which can complicate a production facility. According to the above manufacturing method, the pH of the solution is less likely to be decreased owing to the pH buffering agent, so hydrogen fluoride is less likely to be generated. Therefore, the above manufacturing method has an advantage also in terms of safety and manufacturing cost.

The pH of the above solution is not limited to a particular value as long as a capacitor can be produced. The pH of the above solution is, for example, 4 or more and 12 or less. In this case, a high-performance capacitor is likely to be produced. When the pH of the above solution is 4 or more, the dielectric layer is likely to have desired insulation properties and hydrogen fluoride is less likely to be generated, so the capacitor manufacturing method is likely to be safer. When the pH of the above solution is 12 or less, dissolution of the metallic tantalum in the solution can be prevented.

A concentration of the fluoride and a concentration of the pH buffering agent in the above solution are not limited to particular values as long as a capacitor can be produced. The concentration of the fluoride in the above solution is, for example, more than 0 mol/L and 15 mol/L or less. The concentration of the pH buffering agent in the above solution is, for example, more than 0 mol/L and 1.5 mol/L or less. In this case, a high-performance capacitor is likely to be produced.

As long as a capacitor can be produced, the fluoride in the above solution is not limited to a particular fluoride, and the pH buffering agent in the above solution is not limited to a particular pH buffering agent. The fluoride includes, for example, at least one selected from the group consisting of sodium fluoride, potassium fluoride, ammonium hydrogen fluoride, and ammonium fluoride. The pH buffering agent includes at least one selected from the group consisting of sodium hydrogen phosphate, potassium hydrogen phosphate, ammonium hydrogen phosphate, potassium hydrogen phthalate, sodium citrate, sodium hydrogen carbonate, and sodium borate. In this case, a high-performance capacitor is likely to be produced.

Other examples of the fluoride are sodium hydrogen fluoride, potassium hydrogen fluoride, lithium fluoride, cesium fluoride, strontium fluoride, lithium monofluorophosphate, sodium monofluorophosphate, potassium monofluorophosphate, lithium hexafluorophosphate, sodium hexafluorophosphate, potassium hexafluorophosphate, ammonium hexafluorophosphate, sodium tetrafluoroborate, potassium tetrafluoroborate, and ammonium tetrafluoroborate.

The sodium hydrogen phosphate being the pH buffering agent is, for example, an aqueous solution containing sodium dihydrogen phosphate and disodium hydrogen phosphate, and, in that case, the pH of the above solution is adjusted, for example, to approximately 7. The pH of the above solution can also be adjusted by adjusting the ratio between the amount of sodium dihydrogen phosphate added and the amount of disodium hydrogen phosphate added. Another example of the sodium hydrogen phosphate being the pH buffering agent is an aqueous solution containing trisodium phosphate and disodium hydrogen phosphate, and the pH of the above solution is adjusted, for example, to approximately 11. The pH of the above solution can also be adjusted by adjusting the ratio between the amount of trisodium phosphate added and the amount of disodium hydrogen phosphate added. The pH buffering agent may be an aqueous solution containing sodium dihydrogen phosphate and dipotassium hydrogen phosphate, and the pH of the above solution is adjusted, for example, to approximately 7. The pH of the above solution can also be adjusted by adjusting the ratio between the amount of sodium dihydrogen phosphate added and the amount of dipotassium hydrogen phosphate added. As shown by these examples, the above solution can be prepared by adjusting a combination of various components that function as the pH buffering agent and the ratio of their amounts without departing from the spirit of the capacitor manufacturing method of the present disclosure.

Other examples of the pH buffering agent are shown below.

Tris(hydroxymethyl)aminomethane+hydrochloric acid (pH range: 7 to 9)

Acid mixture composed of (orthophosphoric acid+glacial acetic acid+boric acid)+sodium hydroxide (pH range: 4 to 12)

Acid mixture composed of (citric acid+potassium dihydrogen phosphate+boric acid+diethylbarbituric acid+hydrochloric acid)+sodium hydroxide (pH range: 4 to 12)

(Boric acid+citric acid)+trisodium phosphate (pH range: 4 to 12)

Potassium hydrogen phthalate+sodium hydroxide (pH range: 4 to 6.2)

Potassium dihydrogen phosphate+sodium hydroxide (pH range: 5.8 to 8)

(Boric acid+potassium chloride)+sodium hydroxide (pH range: 7.8 to 10)

2,4,6-Trimethylpyridine+hydrochloric acid (pH range: 6.4 to 8.3)

Tris(hydroxymethyl)aminomethane+hydrochloric acid (pH range: 7.2 to 9.1)

2-Amino-2-methyl-1,3-propanediol+hydrochloric acid (pH range: 7.8 to 9.7)

3-[4-(2-Hydroxyethyl)-1-piperazinyl]-1-propanesulfonic acid+sodium hydroxide (pH range: 5.3 to 8.1)

Potassium hydrogen citrate+sodium hydroxide (pH range: 4 to 6)

Succinic acid+borax (pH range: 4 to 5.8)

Potassium hydrogen citrate+borax (pH range: 4 to 6)

Potassium dihydrogen phosphate+borax (pH range: 5.8 to 9.2)

Borax+sodium carbonate (pH range: 9.2 to 11)

Hydrochloric acid+sodium carbonate (pH range: 10.2 to 11.2)

Disodium hydrogen phosphate+sodium hydroxide (pH range: 11 to 12)

Disodium hydrogen phosphate+citric acid (pH range: 4 to 8)

Tartaric acid+sodium tartrate (pH range: 4 to 4.5)

Lactic acid+sodium lactate (pH range: 4 to 5.3)

Acetic acid+sodium acetate (pH range: 4 to 6.2)

Ammonium chloride+ammonia water (pH range: 8 to 11)

(Sodium diethylbarbiturate+sodium acetate)+hydrochloric acid (pH range: 4 to 9.2)

Sodium diethylbarbiturate+hydrochloric acid (pH range: 6.8 to 9.2)

N, N-dimethylglycine sodium+hydrochloric acid (pH range: 8.6 to 10.6)

(Glycine+sodium chloride)+hydrochloric acid (pH range: 4 to 4.6)

(Glycine+sodium chloride)+sodium hydroxide (pH range: 8.6 to 12)

Sodium citrate+hydrochloric acid (pH range: 4 to 4.9)

Sodium citrate+sodium hydroxide (pH range: 5 to 6.7)

Borax+hydrochloric acid (pH range: 7.6 to 9.2)

Borax+sodium hydroxide (pH range: 9.3 to 12)

As shown in FIG. 4, for example, in step S11, the metallic tantalum or the tantalum oxide covering the metallic tantalum is immersed in the above solution to bring the solution in contact with the metallic tantalum or the tantalum oxide. The tantalum oxide covering the metallic tantalum is obtained, for example, by anodic oxidation of the metallic tantalum. Next, in step S12, while the metallic tantalum and a counter electrode are disposed in the solution at a given distance, anodic oxidation is performed by applying a given voltage between the metallic tantalum and the counter electrode. A dielectric layer including a fluorine-containing tantalum oxide is formed by this on the metallic tantalum. A heating treatment and an anodic oxidation treatment with different conditions may be performed after step S12.

Next, a cathode is formed in step S13. The cathode is formed so that the dielectric layer will be located between the cathode and the metallic tantalum in a thickness direction of the dielectric layer. The cathode is formed, for example, by a known method for forming a cathode to be included in an electrolytic capacitor. A capacitor can be produced in this manner. The formation of the dielectric layer is followed by, for example, attachment of a terminal and encapsulation, if necessary.

### (Supplement)

According to the above description, the following techniques are disclosed.

### (Technique 1)

A capacitor including:
metallic tantalum; and
a dielectric layer covering the metallic tantalum and including a tantalum oxide, wherein
the dielectric layer includes fluorine and phosphorus.

### (Technique 2)

The capacitor according to Technique 1, wherein
the dielectric layer includes a first portion separated from the metallic tantalum in a thickness direction of the dielectric layer and a second portion in contact with the metallic tantalum in the thickness direction of the dielectric layer,
the first portion and the second portion include fluorine, and
a concentration of phosphorus in the first portion is higher than a concentration of phosphorus in the second portion.

### (Technique 3)

The capacitor according to Technique 2, wherein the first portion includes a surface of the dielectric layer.

### (Technique 4)

The capacitor according to any one of Techniques 1 to 3, wherein the dielectric layer includes phosphorus in a surface thereof on a side opposite to the metallic tantalum in a thickness direction of the dielectric layer.

### (Technique 5)

The capacitor according to any one of Techniques 1 to 4, wherein the tantalum oxide is amorphous.

### (Technique 6)

An electrical circuit including the capacitor according to any one of Techniques 1 to 5, wherein the capacitor is mounted to the electrical circuit.

### (Technique 7)

A circuit board including the capacitor according to any one of Techniques 1 to 5, wherein the capacitor is mounted to an electrical circuit formed on the circuit board.

### (Technique 8)

An apparatus including the capacitor according to any one of Techniques 1 to 5, wherein
the capacitor is mounted to an electrical circuit formed on a circuit board, and
the apparatus is equipped with the circuit board.

### (Technique 9)

A capacitor manufacturing method including:
bringing a solution into contact with metallic tantalum or a tantalum oxide covering the metallic tantalum, the solution containing a fluoride including a fluoride ion and a pH buffering agent; and
forming a dielectric layer covering the metallic tantalum by anodic oxidation with the metallic tantalum or the tantalum oxide in contact with the solution.

### (Technique 10)

The capacitor manufacturing method according to Technique 9, wherein a pH of the solution is 4 or more and 12 or less.

### (Technique 11)

The capacitor manufacturing method according to Technique 9 or 10, wherein
a concentration of the fluoride in the solution is more than 0 mol/L and 15 mol/L or less, and
a concentration of the pH buffering agent in the solution is more than 0 mol/L and 1.5 mol/L or less.

### (Technique 12)

The capacitor manufacturing method according to any one of Techniques 9 to 11, wherein
the fluoride includes at least one selected from the group consisting of sodium fluoride, potassium fluoride, ammonium hydrogen fluoride, and ammonium fluoride, and
the pH buffering agent includes at least one selected from the group consisting of sodium hydrogen phosphate, potassium hydrogen phosphate, ammonium hydrogen phosphate, potassium hydrogen phthalate, sodium citrate, sodium hydrogen carbonate, and sodium borate.

### EXAMPLES

Hereinafter, the present disclosure will be described in more detail with reference to examples. The examples given below are just examples, and the present disclosure is not limited to them.

### Example 1

Ultrasonic cleaning was performed for 10 minutes with a flat plate of metallic tantalum immersed in acetone, thereby cleaning the surface of the metallic tantalum. After that, acetone on the surface of the metallic tantalum was dried by nitrogen blowing, and the surface of the metallic tantalum was washed with pure water. The metallic tantalum was then dried in air to give an anode foil.

The above anode foil and a metallic tantalum plate as a counter electrode were disposed such that they were partially immersed in an aqueous phosphoric acid solution with a given distance therebetween. The portion of the anode foil above the surface of the aqueous phosphoric acid solution was connected to a positive electrode of a power-supply device, while the portion of the metallic tantalum plate above the surface of the aqueous phosphoric acid solution was connected to a negative electrode of the power-supply device. A voltage of 15 V was applied between the anode foil and the metallic tantalum plate for 13 hours to form an oxide layer including tantalum oxide on the surface of the anode foil. Then, the anode foil was taken out of the aqueous phosphoric acid solution, washed with pure water, and then dried in air.

Next, the above anode foil with the oxide layer and a metallic tantalum plate as a counter electrode were disposed such that they were partially immersed in a fluoride-containing aqueous solution according to Example 1 with a given distance therebetween. The fluoride-containing aqueous solution according to Example 1 included ammonium hydrogen fluoride and, as a pH buffering agent, ammonium dihydrogen phosphate and diammonium hydrogen phosphate. The concentration of ammonium hydrogen fluoride in the fluoride-containing aqueous solution according to Example 1 was 0.1 mol/L, and the concentration of the buffering agent therein was 0.05 mol/L. The fluoride-containing aqueous solution according to Example 1 further included sodium hydroxide. The pH of the fluoride-containing aqueous solution according to Example 1 was 6.5. The portion of the anode foil above the surface of the fluoride-containing aqueous solution according to Example 1 was connected to a positive electrode of a power-supply device, while the portion of the metallic tantalum plate above the surface of the fluoride-containing aqueous solution was connected to a negative electrode of the power-supply device. A voltage of 45 V was applied between the anode foil and the metallic tantalum plate for four hours to form a fluorine-including tantalum oxide layer. The anode foil was taken out of the fluoride-containing aqueous solution, washed with pure water, and then dried in air. A sample according to Example 1 in which a dielectric layer was provided on the surface of metallic tantalum was obtained in this manner.

### Comparative Example 1

Ultrasonic cleaning was performed for 10 minutes with a flat plate of metallic tantalum immersed in acetone, thereby cleaning the surface of the metallic tantalum. After that, acetone on the surface of the metallic tantalum was dried by nitrogen blowing, and the surface of the metallic tantalum was washed with pure water. The metallic tantalum was then dried in air to give an anode foil.

The above anode foil and a metallic tantalum plate as a counter electrode were disposed such that they were partially immersed in an aqueous phosphoric acid solution with a given distance therebetween. The portion of the anode foil above the surface of the aqueous phosphoric acid solution was connected to a positive electrode of a power-supply device, while the portion of the metallic tantalum plate above the surface of the aqueous phosphoric acid solution was connected to a negative electrode of the power-supply device. A voltage of 15 V was applied between the anode foil and the metallic tantalum plate for 13 hours to form an oxide layer including tantalum oxide on the surface of the anode foil. Then, the anode foil was taken out of the aqueous phosphoric acid solution, washed with pure water, and then dried in air.

Next, the above anode foil with the oxide layer and a metallic tantalum plate as a counter electrode were disposed such that they were partially immersed in a 0.1 mol/L aqueous ammonium hydrogen fluoride solution with a given distance therebetween. The pH of the aqueous solution was 3.0. The portion of the anode foil above the surface of the aqueous ammonium hydrogen fluoride solution was connected to a positive electrode of a power-supply device, while the portion of the metallic tantalum plate above the surface of the aqueous ammonium hydrogen fluoride solution was connected to a negative electrode of the power-supply device. A voltage of 45 V was applied between the anode foil and the metallic tantalum plate for four hours to form a fluorine-including tantalum oxide layer. The anode foil was taken out of the aqueous ammonium hydrogen fluoride solution, washed with pure water, and then dried in air. A sample according to Comparative Example 1 in which a dielectric layer was provided on the surface of metallic tantalum was obtained in this manner.

### (Evaluation of Capacitance and Dielectric Loss Tangent)

Each of the samples according to Example 1 and Comparative Example 1 was attached to a plate electrode evaluating cell manufactured by BAS Inc., and the capacitance and the dielectric loss tangent thereof were evaluated according to an AC impedance method using an aqueous sulfuric acid solution as an electrolyte solution and platinum as a counter electrode. The values of the capacitance and the dielectric loss tangent were values at 120 Hz. The evaluation was performed at room temperature (from 20° C. to 30° C.). Table 1 shows the results.

### (Evaluation of Withstand Voltage)

Each of the samples according to Example 1 and Comparative Example 1 was attached to a plate electrode evaluating cell manufactured by BAS Inc., and the withstand voltage thereof was evaluated by chronovoltammetry using an aqueous phosphoric acid solution as an electrolyte solution and platinum as a counter electrode. The constant current value in the voltammetric measurement was 1 μA, and the withstand voltage value was a voltage value measured after five minutes. The evaluation was performed at room temperature (from 20° C. to 30° C.). Table 1 shows the results.

As shown in Table 1, for the sample according to Comparative Example 1, a leakage current was too high to evaluate the capacitance and the dielectric loss tangent, while the withstand voltage was low. Therefore, it is difficult to say that the dielectric layer of the sample according to Comparative Example 1 is suitable for a capacitor. On the other hand, the sample according to Example 1 exhibited a capacitance, a dielectric loss tangent, and a withstand voltage that are desirable from the viewpoint of use as a capacitor. The comparison of Example 1 with Comparative Example 1 indicates that in a case where an anodic oxidation treatment is performed for a long time using a fluoride-containing aqueous solution, inclusion of a pH buffering agent in the fluoride-containing aqueous solution is advantageous in terms of increasing the capacitance and the withstand voltage of a capacitor.

TABLE 1

| | Fluoride-containing aqueous solution | | | | | Dielectric | Withstand |
|---|---|---|---|---|---|---|---|
| | | pH buffering | | | Capacitance | loss | voltage |
| | Fluoride | agent | Others | pH | [μF] | tangent | [V] |
| Example 1 | NH₄HF₂ | NH₄H₂PO₄ | NaOH | 6.5 | 0.135 | 0.0134 | 47.4 |
| | 0.1 mol/L | (NH₄)₂HPO₄ | | | | | |
| | | 0.05 mol/L | | | | | |
| Comparative | NH₄HF₂ | N/A | N/A | 3.0 | Not | Not | 0.6 |
| Example 1 | 0.1 mol/L | | | | measurable | measurable | |

### Example 2 to Example 7

Ultrasonic cleaning was performed for 10 minutes with a flat plate of metallic tantalum immersed in acetone, thereby cleaning the surface of the metallic tantalum. After that, acetone on the surface of the metallic tantalum was dried by nitrogen blowing, and the surface of the metallic tantalum was washed with pure water. The metallic tantalum was then dried in air to give an anode foil.

The above anode foil and a metallic tantalum plate as a counter electrode were disposed such that they were partially immersed in an aqueous phosphoric acid solution with a given distance therebetween. The portion of the anode foil above the surface of the aqueous phosphoric acid solution was connected to a positive electrode of a power-supply device, while the portion of the metallic tantalum plate above the surface of the aqueous phosphoric acid solution was connected to a negative electrode of the power-supply device. A voltage of 18 V was applied between the anode foil and the metallic tantalum plate for 13 hours to form an oxide layer including tantalum oxide on the surface of the anode foil. Then, the anode foil was taken out of the aqueous phosphoric acid solution, washed with pure water, and then dried in air.

Next, the above anode foil with the oxide layer and a metallic tantalum plate as a counter electrode were disposed such that they were partially immersed in a fluoride-containing aqueous solution according to each Example shown in Table 2 with a given distance therebetween. Table 2 shows the types and the concentrations of fluorides and pH buffering agents in the fluoride-containing aqueous solutions according to Examples 2 to 7 and the pH of the fluoride-containing aqueous solutions according to Examples 2 to 7. The portion of the anode foil above the surface of the fluoride-containing aqueous solution according to each Example was connected to a positive electrode of a power-supply device, while the portion of the metallic tantalum plate above the surface of the fluoride-containing aqueous solution was connected to a negative electrode of the power-supply device. A voltage of 45 V was applied between the anode foil and the metallic tantalum plate for four hours to form a fluorine-including tantalum oxide layer. The anode foil was taken out of the fluoride-containing aqueous solution, washed with pure water, and then dried in air.

Next, the above anode foil with the fluorine-including oxide layer was subjected to a thermal treatment in air under conditions of 260° C. for two hours. The anode foil cooled to room temperature after the thermal treatment and a metallic tantalum plate as a counter electrode were disposed such that they were partially immersed in an aqueous phosphoric acid solution with a given distance therebetween. The portion of the anode foil above the surface of the aqueous phosphoric acid solution was connected to a positive electrode of a power-supply device, while the portion of the metallic tantalum plate above the surface of the aqueous phosphoric acid solution was connected to a negative electrode of the power-supply device. A voltage of 44.5 V was applied between the anode foil and the metallic tantalum plate for 30 minutes to perform restoration conversion. The anode foil was taken out of the aqueous phosphoric acid solution, washed with pure water, and then dried in air. Samples according to Examples 2 to 7 in which a dielectric layer was provided on the surface of metallic tantalum were obtained in this manner.

### Comparative Example 2

Ultrasonic cleaning was performed for 10 minutes with a flat plate of metallic tantalum immersed in acetone, thereby cleaning the surface of the metallic tantalum. After that, acetone on the surface of the metallic tantalum was dried by nitrogen blowing, and the surface of the metallic tantalum was washed with pure water. The metallic tantalum was then dried in air to give an anode foil.

The above anode foil and a metallic tantalum plate as a counter electrode were disposed such that they were partially immersed in an aqueous phosphoric acid solution with a given distance therebetween. The portion of the anode foil above the surface of the aqueous phosphoric acid solution was connected to a positive electrode of a power-supply device, while the portion of the metallic tantalum plate above the surface of the aqueous phosphoric acid solution was connected to a negative electrode of the power-supply device. A voltage of 40 V was applied between the anode foil and the metallic tantalum plate for 13 hours to form an oxide layer including tantalum oxide on the surface of the anode foil. Then, the anode foil was taken out of the aqueous phosphoric acid solution, washed with pure water, and then dried in air. A sample according to Comparative Example 2 in which a dielectric layer was provided on the surface of metallic tantalum was obtained in this manner.

### (Evaluation of Q Value)

Each of the samples according to Examples 2 to 7 and Comparative Example 2 was attached to a plate electrode evaluating cell manufactured by BAS Inc., and the capacitance thereof was evaluated according to an AC impedance method using an aqueous sulfuric acid solution as an electrolyte solution and platinum as a counter electrode. The value of the capacitance was a value at 120 Hz. The evaluation was performed at room temperature (from 20° C. to 30° C.).

Each of the samples according to Examples 2 to 7 and Comparative Example 2 was attached to a plate electrode evaluating cell manufactured by BAS Inc., and the withstand voltage thereof was evaluated by chronovoltammetry using an aqueous phosphoric acid solution as an electrolyte solution and platinum as a counter electrode. The constant current value in the voltammetric measurement was 1 μA, and the withstand voltage value was determined as a voltage value measured after five minutes. The evaluation was performed at room temperature (from 20° C. to 30° C.).

A Q value was determined as a product of the above capacitance and the above withstand voltage, and the Q value of each of the samples according to Examples 2 to 7 was normalized by the Q value (Q_{ref}) of the sample according to Comparative Example 2. This normalization allows evaluation of improvement in capacitor performance attributable to inclusion of fluorine in the dielectric layer.

As shown in Table 2, the capacitance and the withstand voltage were measurable for the samples according to Examples 2 to 7, and improvement in capacitor performance attributable to inclusion of fluorine in the dielectric layer was confirmed from the Q values of each sample.

TABLE 2

| | Fluoride-containing aqueous solution | | | |
|---|---|---|---|---|
| | | pH buffering agent | | Normalized |
| | Fluoride and its | and its | | Q value |
| | concentration | concentration | pH | (Q/Q_{ref}) |
| Example 2 | KF | KH₂PO₄ and | 6.7 | 1.06 |
| | 1.0 mol/L | K₂HPO₄ | | |
| | | 0.05 mol/L | | |
| Example 3 | KF | K₂HPO₄ and K₃PO₄ | 11.5 | 1.15 |
| | 1.0 mol/L | 0.05 mol/L | | |
| Example 4 | KF | KH₂PO₄ and | 9.0 | 1.06 |
| | 10.5 mol/L | K₂HPO₄ | | |
| | | 0.05 mol/L | | |
| Example 5 | KF | Potassium | 4.7 | 1.07 |
| | 0.1 mol/L | hydrogen phthalate | | |
| | | C₈H₅KO₄ | | |
| | | 0.05 mol/L | | |
| Example 6 | NaF | NaHCO₃ and | 10.2 | 1.07 |
| | 0.1 mol/L | Na₂CO₃ | | |
| | | 0.05 mol/L | | |
| Example 7 | KF | KH₂PO₄ and | 7.0 | 1.07 |
| | 0.1 mol/L | K₂HPO₄ | | |
| | | 1 mol/L | | |
| Comparative | Not used | | | 1 |
| Example 2 | | | | |

### Example 8 to Example 13

In a state where one end in a longitudinal direction of an anode lead formed of a metallic tantalum rod was embedded in metallic tantalum powder, the tantalum powder was formed into a rectangular parallelepiped to give a formed body. This formed body was sintered to give an anode body that had a porous structure and where the one end of the anode lead was embedded.

The above anode body and a porous metallic tantalum body substantially identical thereto as a counter electrode were disposed such that they were partially immersed in an aqueous phosphoric acid solution with a given distance therebetween. The portion of the rod of the anode body above the surface of the aqueous phosphoric acid solution was connected to a positive electrode of a power-supply device, while the portion of the rod of the porous metallic tantalum body above the surface of the aqueous solution was connected to a negative electrode of the power-supply device. A voltage of 50 V was applied between the anode body and the porous metallic tantalum body for 13 hours to form an oxide layer including tantalum oxide on the surface of the anode body. Then, the anode body was taken out of the aqueous solution, washed with pure water, and then dried in air.

Next, the above anode body with the oxide layer and a porous metallic tantalum body as a counter electrode were disposed such that they were partially immersed in a fluoride-containing aqueous solution according to each Example shown in Table 3 with a given distance therebetween. Table 3 shows the types and the concentrations of fluorides and pH buffering agents in the fluoride-containing aqueous solutions according to Examples 8 to 13 and the pH of the fluoride-containing aqueous solutions according to Examples 8 to 13. The portion of the rod of the anode body above the surface of the fluoride-containing aqueous solution was connected to a positive electrode of a power-supply device, while the portion of the rod of the porous metallic tantalum body above the surface of the fluoride-containing aqueous solution was connected to a negative electrode of the power-supply device. A voltage of 95 V was applied between the anode body and the porous metallic tantalum body for four hours to form a fluorine-including tantalum oxide layer. The anode body was taken out of the fluoride-containing aqueous solution, washed with pure water, and then dried in air.

Next, the above anode body with the fluorine-including oxide layer was subjected to a thermal treatment in air under conditions of 200° C. for 30 minutes. The anode body cooled to room temperature after the thermal treatment and a porous metallic tantalum body as a counter electrode were disposed such that they were partially immersed in an aqueous phosphoric acid solution with a given distance therebetween. The portion of the rod of the anode body above the surface of the aqueous phosphoric acid solution was connected to a positive electrode of a power-supply device, while the portion of the rod of the porous metallic tantalum body above the surface of the aqueous phosphoric acid solution was connected to a negative electrode of the power-supply device. A voltage of 94 V was applied between the anode body and the porous metallic tantalum body for 30 minutes to perform restoration conversion. The anode body was taken out of the aqueous phosphoric acid solution, washed with pure water, and then dried in air. Samples according to Examples 8 to 13 in which a dielectric layer was provided on the surface of metallic tantalum were obtained in this manner.

### Comparative Example 3

In a state where one end in a longitudinal direction of an anode lead formed of a metallic tantalum rod was embedded in metallic tantalum powder, the tantalum powder was formed into a rectangular parallelepiped to give a formed body. This formed body was sintered to give an anode body that had a porous structure and where the one end of the anode lead was embedded.

The above anode body and a porous metallic tantalum body substantially identical thereto as a counter electrode were disposed such that they were partially immersed in an aqueous phosphoric acid solution with a given distance therebetween. The portion of the rod of the anode body above the surface of the aqueous phosphoric acid solution was connected to a positive electrode of a power-supply device, while the portion of the rod of the porous metallic tantalum body above the surface of the aqueous phosphoric acid solution was connected to a negative electrode of the power-supply device. A voltage of 80 V was applied between the anode body and the porous metallic tantalum body for 13 hours to form an oxide layer including tantalum oxide on the surface of the anode body. Then, the anode body was taken out of the aqueous phosphoric acid solution, washed with pure water, and then dried in air. A sample according to Comparative Example 3 in which a dielectric layer was provided on the surface of metallic tantalum was obtained in this manner.

### (Evaluation of Q Value)

The capacitance was evaluated according to an AC impedance method using each of the samples according to Examples 8 to 13 and Comparative Example 3 as a working electrode, an aqueous sulfuric acid solution as an electrolyte solution, and a porous metallic tantalum body as a counter electrode. The value of the capacitance was a value at 120 Hz. The evaluation was performed at room temperature (from 20° C. to 30° C.).

The withstand voltage was evaluated by chronovoltammetry using each of the samples according to Examples 8 to 13 and Comparative Example 3 as a working electrode, an aqueous phosphoric acid solution as an electrolyte solution, and a SUS plate as a counter electrode. The constant current value in the voltammetric measurement was 1 μA, and the withstand voltage value was a value measured after five minutes. The evaluation was performed at room temperature (from 20° C. to 30° C.).

A Q value was determined as a product of the above capacitance and the above withstand voltage, and the Q value of each of the samples according to Examples 8 to 13 was normalized by the Q value (Q_{ref}) of the sample according to Comparative Example 3. This normalization allows evaluation of improvement in capacitor performance attributable to inclusion of fluorine in the dielectric layer.

As shown in Table 3, the capacitance and the withstand voltage were measurable for the samples according to Examples 8 to 13, and improvement in capacitor performance attributable to inclusion of fluorine in the dielectric layer was confirmed from the Q values of each sample.

TABLE 3

| | Fluoride-containing aqueous solution | | | Normalized |
|---|---|---|---|---|
| | Fluoride and its | pH buffering agent | | Q value |
| | concentration | and its concentration | pH | (Q/Q_{ref}) |
| Example 8 | NaF | Citric acid C₆H₈O₇ | 5.7 | 1.08 |
| | 0.1 mol/L | and trisodium citrate | | |
| | | dihydrate C₆H₅Na₃O₇ | | |
| | | 0.5 mol/L | | |
| Example 9 | NaF | NaH₂PO₄ and | 6.7 | 1.11 |
| | 0.1 mol/L | Na₂HPO₄ | | |
| | | 0.1 mol/L | | |
| Example 10 | NaF | Na₂B₄O₇ | 9.2 | 1.02 |
| | 0.1 mol/L | 0.1 mol/L | | |
| Example 11 | NaF | Na₂B₄O₇ | 9.2 | 1.02 |
| | 0.01 mol/L | 0.01 mol/L | | |
| Example 12 | NH₄F | NaH₂PO₄ and | 6.6 | 1.09 |
| | 0.1 mol/L | Na₂HPO₄ | | |
| | | 0.1 mol/L | | |
| Example 13 | KF | NaH₂PO₄ and | 6.8 | 1.13 |
| | 0.1 mol/L | Na₂HPO₄ | | |
| | | 0.05 mol/L | | |
| Comparative | Not used | | | 1 |
| Example 3 | | | | |

### (Elemental Composition Analysis)

A piece having a given size was cut out of the sample according to Example 1, and a specimen for time-of-flight secondary ion mass spectrometry (TOF-SIMS) was prepared by resin embedding. TOF-SIMS measurement was performed on the specimen prepared from the sample according to Example 1 using a TOF-SIMS apparatus TOF. SIMS 5 manufactured by IONTOF GmbH so as to perform composition analysis in the depth direction of the dielectric layer. In the TOF-SIMS, a Bi ion beam was used as a primary ion beam. O²⁺ was used as a sputtering ion species.

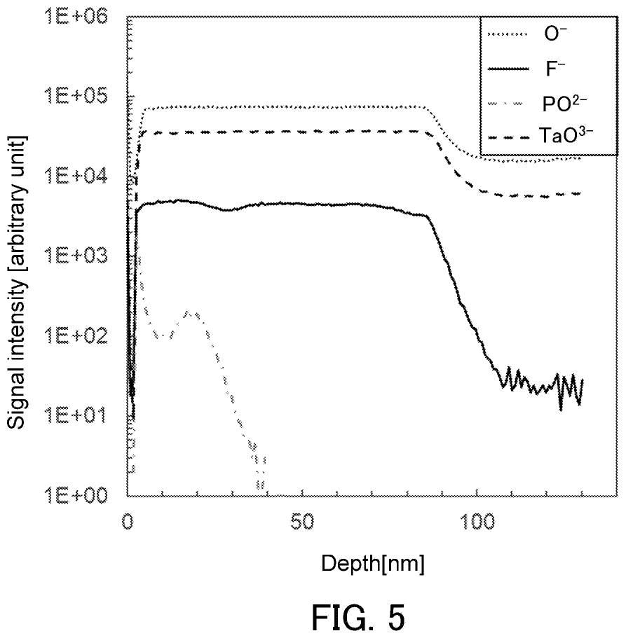

FIG. 5 is a graph showing a relation between signal intensities of F⁻, PO²⁻, TaO³⁻, and O⁻ and the depth in a depth profile obtained from the sample according to Example 1 by TOF-SIMS. In FIG. 5, the vertical axis represents the signal intensity of each ion, and the horizontal axis represents the depth of the dielectric layer. It is understood from FIG. 5 that the dielectric layer of the sample according to Example 1 was present from the surface of the dielectric layer to a depth of approximately 90 nm, and was formed on the metallic tantalum. A fluorine-including portion was present from the surface of the dielectric layer to a depth of approximately 90 nm. On the one hand, a phosphorus-including portion was present from the surface of the dielectric layer to a depth of approximately 26 nm. The fluorine-including portion may include a portion having a higher fluorine concentration on the surface side of the dielectric layer and a portion having a lower fluorine concentration on the metallic tantalum side. In order to sufficiently enhance the improvement in the capacitor performance attributable to addition of fluorine, the presence of fluorine throughout the entire thickness of the dielectric layer is advantageous. To this end, anodic oxidation conditions are adjusted so that fluorine is present in what is called an inner layer of the anodic film. Consequently, the fluorine-including portion can be present in a deeper area of the anodic film, the deeper region being closer to the metallic tantalum than the portion including fluorine and phosphorus. It can be said that the sample according to Example 1 is an example where fluorine is present as deep as possible, the portion having a lower fluorine concentration is minimized, and the fluorine-including portion is also present closer to the metallic tantalum than the portion including fluorine and phosphorus.

### (X-Ray Diffraction)

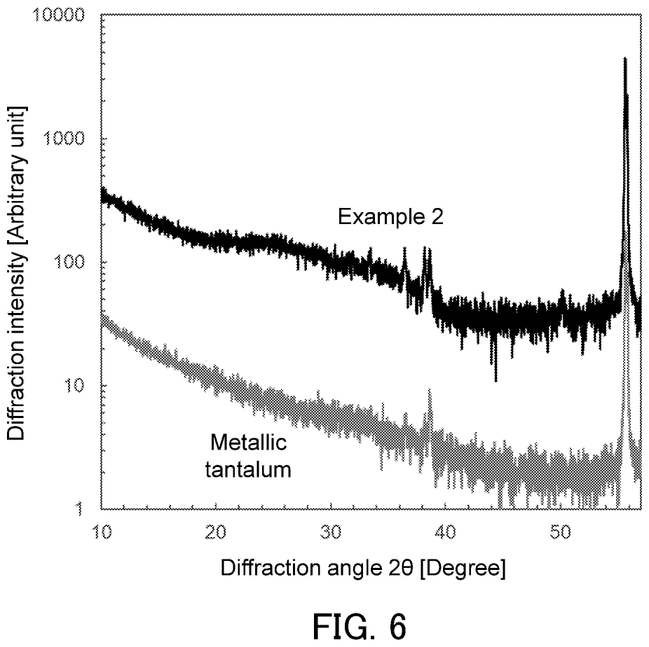

An XRD pattern of a specimen produced from the sample according to Example 2 was obtained by 2θ/θ scan using an X-ray diffractometer X′Pert PRO manufactured by Malvern Panalytical Ltd. Cu-Kα radiation was used as an X-ray source, the voltage was adjusted to 45 kV, and the current was adjusted to 40 mA. The wavelength of the Cu-Kα radiation was 0.15418 nm. FIG. 6 is a graph showing the results of the X-ray diffraction (XRD) measurement of the sample according to Example 2 and metallic tantalum. In FIG. 6, the vertical axis represents the diffraction intensity in arbitrary unit, and the horizontal axis represents the diffraction angle 2θ. As shown in FIG. 6, in the result of the XRD measurement of the sample according to Example 2, a broad profile was observed over the entire pattern although diffraction peaks derived from metallic tantalum was observed. This indicates that the fluorine-containing tantalum oxide included in the dielectric layer of the sample according to Example 2 is amorphous. Considering the production conditions and the like of the sample, it is thought that the fluorine-containing tantalum oxides included in the dielectric layers of the samples according to the other Examples are also amorphous.

### INDUSTRIAL APPLICABILITY

The capacitor of the present disclosure is useful in applications where a high capacitance and a high withstand voltage are required.

What is claimed is:

1. A capacitor comprising:
metallic tantalum; and
a dielectric layer covering the metallic tantalum and including a tantalum oxide, wherein
the dielectric layer includes fluorine and phosphorus.

2. The capacitor according to claim 1, wherein
the dielectric layer includes a first portion separated from the metallic tantalum in a thickness direction of the dielectric layer and a second portion in contact with the metallic tantalum in the thickness direction of the dielectric layer,
the first portion and the second portion include fluorine, and
a concentration of phosphorus in the first portion is higher than a concentration of phosphorus in the second portion.

3. The capacitor according to claim 2, wherein the first portion includes a surface of the dielectric layer.

4. The capacitor according to claim 1, wherein the dielectric layer includes phosphorus in a surface thereof on a side opposite to the metallic tantalum in a thickness direction of the dielectric layer.

5. The capacitor according to claim 1, wherein the tantalum oxide is amorphous.

6. An electrical circuit comprising the capacitor according to claim 1, wherein the capacitor is mounted to the electrical circuit.

7. A circuit board comprising the capacitor according to claim 1, wherein the capacitor is mounted to an electrical circuit formed on the circuit board.

8. An apparatus comprising the capacitor according to claim 1, wherein the capacitor is mounted to an electrical circuit formed on a circuit board, and the apparatus is equipped with the circuit board.

9. A capacitor manufacturing method comprising:
bringing a solution into contact with metallic tantalum or a tantalum oxide covering the metallic tantalum, the solution containing a fluoride including a fluoride ion and a pH buffering agent; and
forming a dielectric layer covering the metallic tantalum by anodic oxidation with the metallic tantalum or the tantalum oxide in contact with the solution.

10. The capacitor manufacturing method according to claim 9, wherein a pH of the solution is 4 or more and 12 or less.

11. The capacitor manufacturing method according to claim 9, wherein
a concentration of the fluoride in the solution is more than 0 mol/L and 15 mol/L or less, and
a concentration of the pH buffering agent in the solution is more than 0 mol/L and 1.5 mol/L or less.

12. The capacitor manufacturing method according to claim 9, wherein
the fluoride includes at least one selected from the group consisting of sodium fluoride, potassium fluoride, ammonium hydrogen fluoride, and ammonium fluoride, and
the pH buffering agent includes at least one selected from the group consisting of sodium hydrogen phosphate, potassium hydrogen phosphate, ammonium hydrogen phosphate, potassium hydrogen phthalate, sodium citrate, sodium hydrogen carbonate, and sodium borate.
